(19) United States
(12) Patent Application Publication
(10) Pub. No.: US 2008/0270959 A1
(43) Pub. Date: Oct. 30, 2008

(54) Influencing functional simulation of a system by timing simulation of the system

(76) Inventors: Paolo Faraboschi, Barcelona (ES); Ayose Falcon, Barcelona (ES); Daniel Ortega, Sant Cugat (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/740,254

(22) Filed: Apr. 25, 2007

(51) Int. Cl. G06F 17/50

(52) U.S. Cl. 716/6

(57) ABSTRACT

A method performs functional simulation of a system as influenced by timing simulation of the system. The method performs functional simulation of a system, and periodically performs timing simulation of the system. The functional simulation of the system takes into account the timing simulation of the system that is periodically performed.

### BACKGROUND

Simulating system execution of applications made up of instructions (viz., processor instructions) is commonly performed. Typically, such simulation is performed to ensure that the system and the applications operate as they are expected or intended to operate. Furthermore, such simulation may be performed to verify that systems, applications, and computer programs that were designed for older, outdated hardware are properly executed using more modern hardware. This type of simulation is known as functional simulation. However, other types of simulation of system execution of instructions are also important.

For instance, another type of simulation simulates how long it will take a system to execute the instructions of a given application. This type of simulation is known as timing simulation. As another example, a type of simulation may simulate how much electrical power the system uses to execute the instructions of a given application. This type of simulation is known as power simulation.

The functional simulation of system execution of instructions is commonly decoupled from the timing simulation of system execution of instructions. This typically permits the functional simulation to be performed much more quickly. However, by divorcing the functional simulation from the timing simulation, the functional simulation of system execution of instructions may not be performed as accurately, since some aspects of system execution of instructions can be dependent on the timing of this execution.

### BRIEF DESCRIPTION OF THE DRAWINGS

FIG. 1 is a diagram of a system for simulating instructions to be executed on a target system, according to an embodiment of the invention.

FIG. 2 is flowchart of a method for performing functional simulation of a target system that takes into account timing simulation of the target system, according to an embodiment of the invention.

FIG. 3 is a timing diagram depicting how the timing simulation of a target system can be periodically performed in relation to the functional simulation of the target system, according to an embodiment of the invention.

FIG. 4 is a flowchart of a method for performing functional simulation of a target system that takes into account timing simulation of the target system, and that is more general than but consistent with the method of FIG. 2, according to an embodiment of the invention.

### DETAILED DESCRIPTION OF THE DRAWINGS

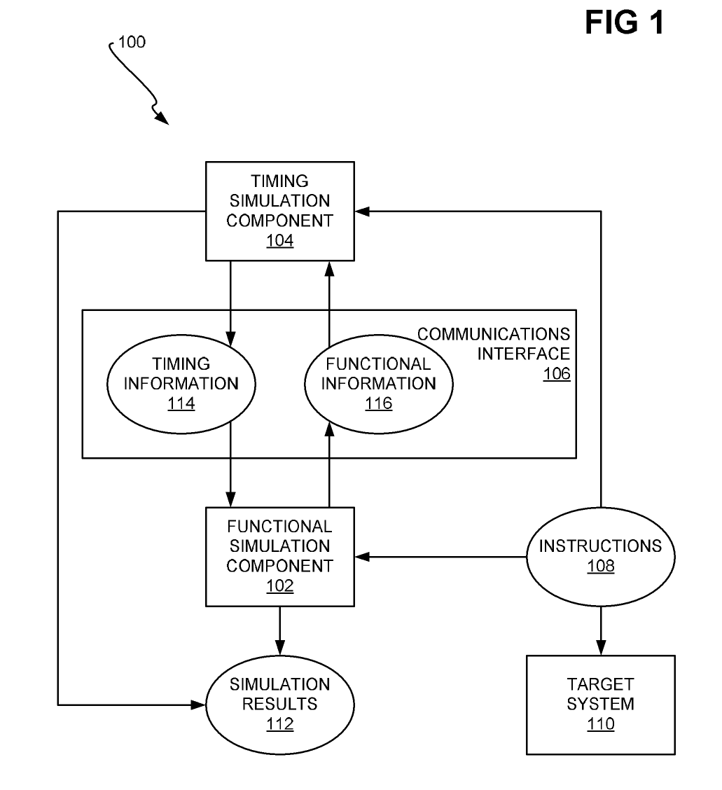

FIG. 1 shows a system 100, according to an embodiment of the invention. The system 100 includes at least a functional simulation component 102 and a timing simulating component 104. The system 100 may be implemented within or over one or more computing devices, such as desktop or laptop computers. The simulation components 102 and 104 may be implemented in hardware, software, or a combination of hardware and software. As can be appreciated by those of ordinary skill within the art, the system 100 may include other components, in addition to the simulation components 102 and 104. As can also be appreciated by those of ordinary skill within the art, the simulation components 102 and 104 can be implemented as is conventional, or in another way.

The functional simulation component 102 simulates functional execution of instructions 108 on a target system 110, whereas the timing simulation component 104 simulates timing execution of the instructions 108 on the target system 110. The instructions 108 may be part of one or more applications to ultimately be executed on the target system 110. The target system 110 itself can be or include one or more computing devices, such as single-processor computer systems, as well as multiple-processor computer systems.

The functional simulation component 102 simulates the functional execution of the instructions 108 on the target system 110, and thus simulates the functional execution of the target system 110, in that the simulation component 102 determines whether the system 110 and the instructions 108 operate as they are expected or intended to operate. That is, the functional simulation component 102 simulates how the target system 110 operates with respect to the instructions 108. The functional simulation component 102 by itself may not provide any timing information, or may not be able to provide sophisticated or substantially accurate timing information; rather, the functional simulation component 102 may just provide relatively simple timing information. Timing information includes the time it takes for the target system 110 to execute the instructions 108.

By comparison, the timing simulation component 104 simulates how long, or how much time, the target system 110 takes to execute the instructions 108. That is, the timing simulation component 104 simulates how long, or how much time, the target system 110 takes to perform an intended task. The timing simulation component 104 does not test whether the target system 110 properly or correctly executes the instructions 108, which instead is the domain of the functional simulation component 104.

The system 100 can include a communication interface 106, which may be a defined communications protocol, for instance, that defines the exchange of information between the simulation components 102 and 104. The functional simulation component 102 provides functional simulation information 116 to the timing simulation component 104. Similarly, the timing simulation component 104 provides timing simulation information 114 to the functional simulation component 102.

Other than the exchange of information between the simulation components 102 and 104 via the communication interface 106, the functional simulation component 102 and the timing simulation component 104 are at least substantially decoupled from one another. For instance, the timing simulation component 104 can be switched out for, or replaced with, a different timing simulation component 104 that is also capable of operating with the functional simulation component 102. The communication interface 106—i.e., the exchange of information between the simulation components 102 and 104—can be considered as recoupling these decoupled simulation components 102 and 104.

In general, the timing simulation component 104 performs its timing simulation more slowly than the functional simulation component 102 performs its functional simulation. As can be appreciated by those of ordinary skill within the art, the functional simulation component 102 can perform various simulation techniques that speed the functional simulation component 102 performing functional simulation of the target system 110 executing the instructions 108. By comparison, lesser such simulation techniques are available for the timing simulation component 104 to speed performance of the timing simulation of the target system 110 executing the instructions 108.

Furthermore, however, the functional simulation component 102 in at least some situations may not be able to accurately simulate the execution of the instructions 108 by the target system 110 without any timing information. In other words, in many cases, the behavior of the target system 110 may directly depend on the simulated time of various events. For example, many multithreaded libraries use active wait loops, as opposed to yielding the processor on a lock, because of the performance advantage of the resulting short waits. As another example, within an application accessing a network, packets may be resent or network parameters adjusted depending on network congestion. In these and other examples, functionally simulating the target system 110 executing the instructions 108 without taking into account timing information results in a less-than-desirable functional simulation.

Therefore, the functional simulation component 102 takes into account the timing simulation of the target system 110 executing the instructions 108 while performing functional simulation of the target system 110. Advantageously, such influence of the functional simulation by the timing simulation occurs without greatly affecting the performance of the functional simulation. In general, the timing simulation component 104 provides periodic timing-related feedback to the functional simulation component 102, as the timing information 114. The functional simulation component 102 then performs its functional simulation based on this timing-related feedback. The timing simulation component 104 can determine this timing information 114 (i.e., the timing-related feedback) based on the functional simulation information 116 generated continuously by the functional simulation component 102.

By providing timing-related feedback periodically, instead of continuously (e.g., such as at the simulation of each of the instructions 108), the timing simulation component 104 helps the functional simulation component 102 provide more accurate functional simulation, without greatly slowing performance of the functional simulation. For example, the functional simulation component 102 may simulate a real-time clock (RTC) of the target system 110, where the system 110 may be able to execute a certain number of the instructions 108 per each clock cycle, which is referred to as instructions per cycle (IPC). Rather than providing timing-related feedback at the simulation of each of the instructions 108 by the functional simulation component 102, the timing simulation component 104 may instead provide such timing-related feedback once per a number of such clock cycles, such as once per one million such simulated clock cycles, where one million (or other number) of such simulated clock cycles is referred to herein as a simulation cycle. As such, a substantially optimal compromise between functional simulation performance and functional simulation accuracy is achieved.

Once the functional and the timing simulations have been completed, the functional simulation component 102 outputs functional simulation results 112, and the timing simulation component 104 may output timing simulation results 112. These simulation results 112 may then be used by a developer or a designer to ensure that the target system 110 is properly executing the instructions 108, in the proper length of time. Described next in the detailed description is a particular approach by which the functional simulation of the target system 110 takes into account the timing simulation of the target system 110 that is periodically performed.

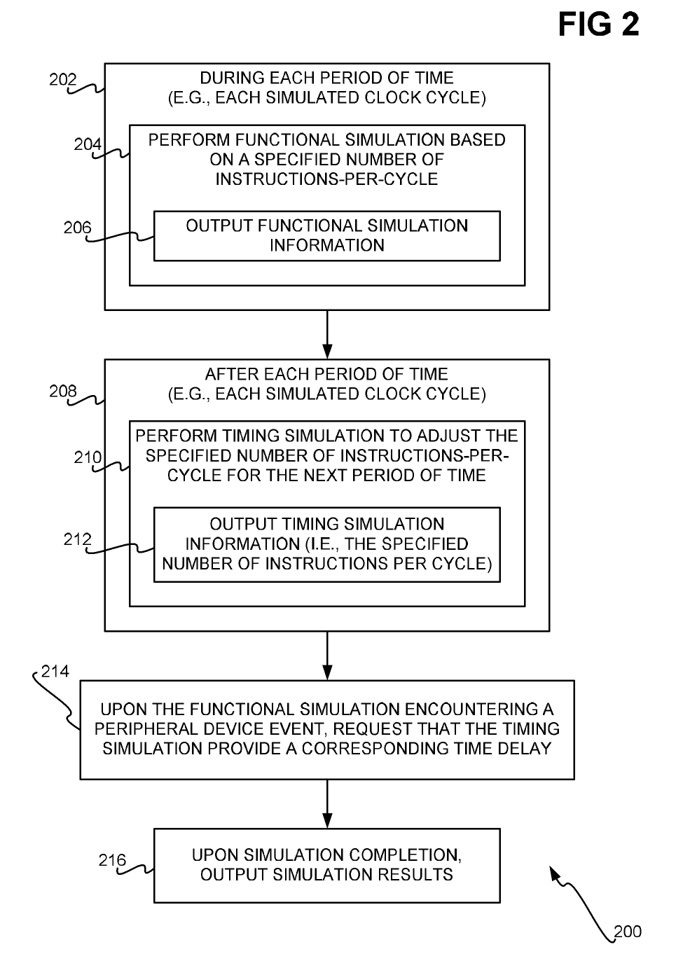

FIG. 2 shows a method 200 for performing functional simulation of a system, where the functional simulation takes into account timing simulation of the system, according to an embodiment of the invention. The method 200 is representatively described in relation to the system 100 of FIG. 1. The method 200 is further described in relation to a number of periods of time of the target system 110 being simulated. For instance, these periods of time in one embodiment can each correspond to one million (simulated) clock cycles of the processor of the target system 110. These periods of time may further be referred to as simulation cycles.

During each such period of time (202), the functional simulation component 102 performs functional simulation based on a specified number of instructions per cycle (204). That is, rather than functionally simulating the target system 110 without regards to how many instructions the system 110 can execute within a given simulation cycle, the functional simulation component 102 instead functionally simulates the target system 110 based on the knowledge that a specified number of instructions per cycle can currently be executed by the target system 110 being simulated. In this sense, the functional simulation component 102 takes into account timing simulation-related information when performing functional simulation. For the first simulation cycle, the specified number of instructions per cycle may be set to a default value. During functional simulation, and as a part of functional simulation, the functional simulation component 102 outputs functional simulation information 116 (206).

Next, after each period of time (208), the timing simulation component 104 performs timing simulation. Particularly, the timing simulation component 104 adjusts the specified number of instructions per cycle that is to be used by the functional simulation component 102 during the next period of time (210). Adjusting the specified number of instructions per cycle may be achieved based on the functional simulation information 116 output by the functional simulation component 102. For instance, the timing simulation component 104 may analyze this information 116 to determine whether there is significant congestion occurring within the target system 110 that may result in a decreased number of instructions that can be executed within system 110 during the next simulation cycle. The timing simulation information 114 (i.e., the specified number of instructions per cycle as adjusted) is output by the timing simulation component 104 (212), for utilization by the functional simulation component 102 when functionally simulating the target system 110 during the next period of time.

It is noted that the actual number of instructions for a given simulation cycle is not able to be determined by the timing simulation component 104, insofar as the specified number of instructions per cycle is determined for a simulation cycle before the functional simulation component 102 simulates the target system 110 in relation to that simulation cycle. In other words, the timing simulation component 104 predicts how many instructions are likely to be able to be executed by the target system 110 during the functional simulation of the system 110 by the functional simulation component 102 in the next simulation cycle. As such, only previous history (i.e., historical data) regarding the simulation of the target system 110 can be employed to predict the instructions per cycle for the next simulation cycle. This previous history can include previous numbers of instructions per cycle actually simulated by the functional simulation component 102, as well as functional simulation information 116 that has been output by the functional simulation component 102 regarding the functional simulation of the target system 110.

In one embodiment, it has been found that an auto-regressive, moving-average (ARMA) model, adequately predicts the number of instructions per cycle for the next simulation cycle. This model can be mathematically described as the inverse of instructions per cycle—i.e., as cycles per instruction—as follows:

$${CPI}_{t + 1} = {\sum }_{i = 0}^{N} {a}_{i} {CPI}_{t - i} + {\sum }_{i = 0}^{M} {m}_{i} ( {CPI}_{t - i} - C \hat{P} {I}_{t - i} ) \qquad ( 1 )$$

In equation one CPIₓ is the average cycles per instruction (CPI) for time period x. The constants a₀, a₁ . . . a_{N} represent the autoregressive parameters (or numbers of poles in the z-transform domain), and the constants m₀, m₁ . . . m_{M} represent the moving average parameters (or numbers of zeros in the z-transform domain). Furthermore, C\hat{P}Iₓ is the previously estimated value of the CPI for time period x, so that the term CPIₓ−C\hat{P}Iₓ represent the previous prediction error at step x. Some examples of specific ARMA models may include an ARMA22 model (two poles, two zeros), corresponding to equation (1) with N=2 and M=2, or a “next-step predictor” model, corresponding to equation (1) with N=1, M=0 and a₀=1.0 In one embodiment, captured by the moving average components of equation (1), any error of the instructions per cycle predicted for a current simulation cycle as compared to the actual number of instructions per cycle for that simulation cycle can be diffused over one or more future simulation cycles.

Based on this timing-related feedback from the timing simulation component 104 to the functional simulation component 102 (i.e., as the timing simulation information 114), the functional simulation of the target system 110 executing the instructions 108 is more accurate. For instance, an application being simulated that encompasses the instructions 108 acts as if execution by the target system 110 were faster or slower. Such timing-related influence on the functional simulation ensures that the functional simulation takes into account real-world issues that the target system 110 may encounter, such as network congestion, and so on. Without such timing-related influence on the functional simulation, the functional simulation otherwise acts as if all the instructions 108 can be executed without regards to time.

Therefore, the simulations of parts 202 and 208 of the method 200 can be seen to operate as follows. During each simulation cycle, the functional simulation component 102 functionally simulates the target system 110 executing the instructions 108, based on the specified number of instructions per cycle. Once per simulation cycle, the timing simulation component 104 performs timing simulation of the target system 110 executing the instructions 108 to adjust the number of instructions per cycle for the next simulation cycle within which functional simulation is to be performed. Such periodic punctuation of the functional simulation with timing simulation ensures that the functional simulation is performed in relation to timing information, without affecting performance of the functional simulation too much.

It is noted that most of the simulation of the target system 110 involves simulating the target system 110 as the system 110 executes the instructions 108. However, relatively infrequent other events also occur. Such events include peripheral device events, such as accessing a network adapter, accessing a hard disk drive, and so on. These peripheral device events are relatively infrequent in that their number is much smaller than the number of instructions executed by the target system 110. However, such peripheral device events may nevertheless affect the functional simulation of the target system 110, in that processing such events can take considerably longer than executing processor instructions. For example, waiting for a hard disk drive access can take milliseconds, whereas a processor instruction can be executed in microseconds.

Therefore, upon the functional simulation being performed by the functional simulation component 102 encounter such a peripheral device event, the functional simulation component 102 calls the timing simulation component 104 to provide a corresponding time delay (214). This time delay is used by the functional simulation component 102 in performing functional simulation of the target system 110, in addition to the other timing simulation information 114 regularly and periodically provided by the timing simulation component 104. For example, the time delay for a hard disk drive write access can be propagated to the model simulating such a hard disk drive, to make the simulated disk drive unavailable for an appropriate duration of time.

Ultimately, the functional simulation that takes into account the timing simulation is completed, at which time the results of the simulation are output (216). The simulation results may be stored in an electronic file, for instance, for later review and analysis by a developer or designer of the target system 110 or of the application encompassing the instructions 108. The simulation results may further be displayed on a display device, or printed as hardcopy by a printing device.

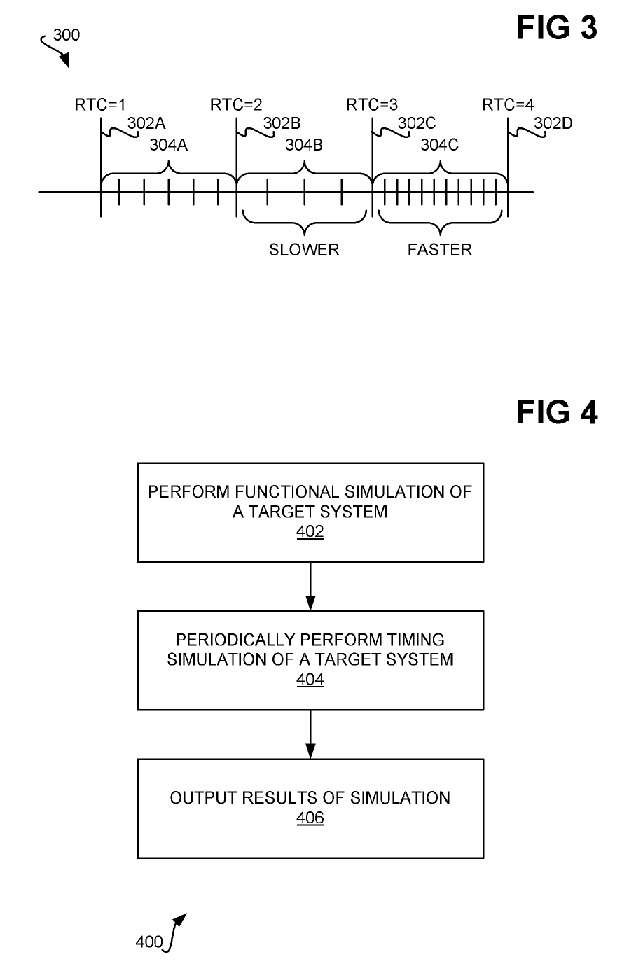

FIG. 3 shows a timing diagram 300 depicting how timing simulation of the target system 110 influences functional simulation of the target system 110, according to an embodiment of the invention. Demarcated within the timing diagram 300 are a number of predetermined sample points 302A, 302B, 302C, and 302D, collectively referred to as the sample points 302. The sample points 302 may correspond to regular and periodic counting of the simulated real-time clock (RTC) of the target system 110, such as at one millisecond intervals. Several time periods 304A, 304B, and 304C, collectively referred to as the time periods 304, are defined by the sample points 302. For example, the time period 304A is between the sample points 302A and 302B, the time period 304B is between the sample points 302B and 302C, and the time period 304C is between the sample points 302C and 302D.

The timing simulation predicts at a given sample point the instructions per cycle to be used during the functional simulation within the next time period. Thus, at sample point 302A, the timing simulation predicts the instructions per cycle to be used during the functional simulation within the time period 304A. At sample point 302B, the timing simulation predicts the instructions per cycle to be used during the functional simulation within the time period 304B. At sample point 302C, the timing simulation predicts the instructions per cycle to be used during the functional simulation within the time period 304C.

In the example of FIG. 3, after predicting a given instructions per cycle value at the sample point 302A for using during functional simulation within the time period 304A, the timing simulation next predicts a slower, or lesser, number of instructions per cycle value at the sample point 302B for using during functional simulation within the time period 304B. Thereafter the timing simulation predicts a faster, or greater, number of instructions per cycle at the sample point 302C for using during functional simulation within the time period 304C. In this way, timing simulation is periodically performed, where the results of this timing simulation influence the functional simulation performed within the immediately next time period, and where the functional simulation is continuously performed.

In conclusion, FIG. 4 shows a method 400 for performing functional simulation of a target system that is influenced by timing simulation of the target system, according to an embodiment of the invention. The method 400 is more general than but consistent with the method 200 of FIG. 2 that has been described. As such, the method 400 may be performed in relation to the system 100 of FIG. 1, although the method 400 is not particularly described in relation to the system 100.

Functional simulation of a target system executing instructions is performed (402). As has been described, such functional simulation includes simulating how the target system in question operates, as opposed to how long it takes for the target system to execution the instructions in question. The functional simulation of the target system is performed at least substantially continuously.

Periodically, timing simulation of the target system executing instructions is performed (404). As has also been described, such timing simulation includes simulating how much time, or how long, it takes for the target system to execute a given portion of the instructions (i.e., perform a given task). The functional simulation of the target system takes into account the periodic timing simulation that is performed. For instance, the timing simulation outputs timing simulation information at the periodic intervals at which it is performed, where this timing simulation information is used by the functional simulation to guide such functional simulation of the target system.

As one example, as has been described in relation to FIG. 3, an instructions-per-cycle value is adjusted at each of a number of predetermined sample points, as the timing simulation of part 404. The instructions-per-cycle value is then used by the functional simulation of part 402 for the next period—before the next sample point—to perform the functional simulation of the target system. For instance, the instructions-per-cycle value may be used as the actual number of instructions per cycle to be simulated during the functional simulation within the next period of time.

Thus, the timing simulation simulates how many instructions the target system is to execute during the next period of time, where this information is used by the functional simulation when functionally simulating the system in this next period of time. The instructions-per-cycle value, or other timing simulation information, is predicted, such as based on historical data regarding the numbers of instructions per cycle previously predicted for prior periods of time, and/or on functional simulation information output during functional simulation. Once the simulation is finished, the results of the simulation are output (406), including the results of the timing and/or functional simulation.

We claim:

1. A method for performing functional simulation of a system as influenced by timing simulation of the system, comprising:
performing functional simulation of a system; and,
periodically performing timing simulation of the system,
wherein the functional simulation of the system takes into account the timing simulation of the system that is periodically performed.

2. The method of claim 1, further comprising outputting results of the functional simulation of the system.

3. The method of claim 1, wherein performing the functional simulation of the system comprises simulating how the system operates.

4. The method of claim 1, wherein periodically performing the timing simulation of the system comprises simulating how much time the system takes to perform an intended task.

5. The method of claim 1, wherein periodically performing the timing simulation of the system comprises, at predetermined sample points, determining a number of instructions-per-cycle that are to be executed during the functional simulation of the system within a next period before a next sample point at which the timing simulation is again performed.

6. The method of claim 5, wherein determining the number of instructions-per-cycle that are to be executed during the functional simulation of the system within the next period before the next sample point at which the timing simulation is performed comprises predicting the number of instructions-per-cycle that are to be executed during the functional simulation of the system within the next period before the next sample point, based on historical data regarding the numbers of instructions-per-cycle that were previously predicted for prior periods before a current sample point.

7. The method of claim 1, wherein periodically performing the timing simulation of the system comprises periodically performing the timing simulation of the system based on information regarding the functional simulation of the system provided by the functional simulation of the system.

8. The method of claim 1, wherein the functional simulation of the system taking into account the timing simulation of the system that is periodically performed comprises the timing simulation of the system periodically outputting timing information, wherein the functional simulation of the system is performed based on the timing information.

9. The method of claim 1, wherein the functional simulation of the system simulates instructions to be executed on the system, and the timing simulation of the system simulates how many instructions the system is to execute during a period of time.

10. A computer-readable medium storing one or more computer programs to perform a method for performing functional simulation of the system as influenced by timing simulation of the system, the method comprising:
during each period of time of a plurality of periods of time,
performing functional simulation of a system based on a specified number of instructions-per-cycle of the system;
after each period of time of the plurality of periods of time,
performing timing simulation of the system to adjust the specified number of instructions-per-cycle of the system for a next period of time,
such that the functional simulation of the system during a current period of time takes into account the timing simulation of the system performed prior to the current period of time via the specified number of instructions-per-cycle of the system being adjusted by the timing simulation of the system.

11. The computer-readable medium of claim 10, the method further comprising outputting results of the functional simulation of the system.

12. The computer-readable medium of claim 10, wherein performing the functional simulation of the system comprises outputting information regarding the functional simulation of the system during a current period of time.

13. The computer-readable medium of claim 12, wherein performing the timing simulation of the system comprises predicting the specified number of instructions-per-cycle for a next period of time based at least on the information regarding the functional simulation of the system during the current period of time.

14. The computer-readable medium of claim 12, wherein predicting the specified number of instructions-per-cycle for the next period of time is further based on historical data regarding the numbers of instructions-per-cycle that were previously predicted for historical periods of time.

15. The computer-readable medium of claim 10, wherein performing the functional simulation of the system comprises, upon encountering a peripheral device event, requesting that the timing simulation provide a time delay based on the peripheral device event, such that the functional simulation of the system in relation to the peripheral device event takes into account the time delay.

16. A system to simulation a target system, comprising:
a functional simulation component to simulate functional operation of the target system during each period of time of a plurality of periods of time, based on a specified instructions-per-cycle of the target system; and,
a timing simulation component to simulate timing of the target system by adjusting the specified instructions-per-cycle of the target system after each period of time.

17. The system of claim 16, wherein the functional simulation component and the timing simulation component are decoupled from one another, such that the timing simulation component is adapted to be switched out at least substantially independently of the functional simulation component.

18. The system of claim 16, further comprising a communication interface between the functional simulation component and the timing simulation component,
wherein the communication interface permits the functional simulation component to provide information regarding the functional simulation of the target system to the timing simulation component on which basis the timing simulation component adjusts the specified instructions-per-cycle of the target system,
and wherein the communication interface permits the timing simulation component to provide information regarding the timing simulation of the target system to the functional simulation component on which basis the functional simulation component simulates the functional operation of the target system.

19. The system of claim 16, wherein the timing simulation component is to predict the specified number of instructions-per-cycle for the a period of time based at least on historical data regarding the numbers of instructions-per-cycle that were previously predicted for historical periods of time.

20. The system of claim 16, wherein the functional simulation component, upon encountering a peripheral device event, is to call the timing simulation component to receive a time delay from the timing simulation component based on the peripheral device event, such that the functional simulation component simulates functional operation of the target system in relation to the peripheral device event by taking into account the time delay.
